(19) United States
(12) Patent Application Publication
(10) Pub. No.: US 2009/0122238 A1
(43) Pub. Date: May 14, 2009

(54) Protection Filter For Liquid Crystal Display

(75) Inventors: Dong-Keun Sin, ChungCheongNam-Do (KR); Ji-Yoon Seo, ChungCheongNam-Do (KR); Moon-Jin Choi, ChungCheongNam-Do (KR); Sang Yoon Oh, ChungCheongNam-Do (KR); Dae Chul Park, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/268,703

(22) Filed: Nov. 11, 2008

(30) Foreign Application Priority Data
Nov. 13, 2007 (KR) 10-2007-0115764

(51) Int. Cl. G02F 1/1335; G02F 1/1333

(52) U.S. Cl. 349/104; 349/137

(57) ABSTRACT

A protection filter for a liquid crystal display (LCD) includes a transparent substrate and a heat-blocking film comprising a metallic compound thin film and a transparent metallic thin film which are alternately formed on the transparent substrate.

### CROSS-REFERENCE TO RELATED APPLICATION

This application claims the benefit of Korean Patent Application No. 2007-0115764 filed on Nov. 13, 2007 with the Korean Intellectual Property Office, the disclosure of which is incorporated herein by reference.

### BACKGROUND OF THE INVENTION

1. Field of the Invention

The present invention relates to a protection filter for a liquid crystal display.

2. Description of the Related Art

As information technology is being developed, the market for a display device as a connecting media between a user and information, extends widely. Thus, growing is the use of a flat panel display (FPD), such as a liquid crystal display (LCD), an organic light emitting display (OLED), a plasma display and the like. Among them, the LCD is being in the spotlight because it can be made in a large size as well as a small size.

The LCD is used in televisions (TVs) as well as a monitor for personal or office desktop computers, and the application thereof is recently getting wider to e.g. a public display (PD).

Since the LCD for PD is generally installed out of doors, it may be directly influenced by external environment. For example, the LCD may be directly exposed to a high temperature environment by glaring sunlight. If the LCD is exposed to the high temperature environment for a long time, the lifetime and display quality of the LCD may deteriorate.

Therefore, a solution to protect an LCD under the high temperature environment is needed.

### SUMMARY OF THE INVENTION

The present invention has been made to solve the foregoing problems with the prior art, and therefore an object of the present invention is to provide a protection filter for a liquid crystal display (LCD), which minimizes an influence by heat even when the liquid crystal display is exposed to a high temperature environment.

Other objects of the present invention may be apparently understood by those skilled in the art, to which the present invention pertains, with reference to the following description.

In order to achieve the above object of the present invention, according to an aspect of the present invention, there is provided a protection filter for a liquid crystal display (LCD) including a transparent substrate and a heat-blocking film including a metallic compound thin film and a transparent metallic thin film which are alternately formed on the transparent substrate.

Details of other embodiments are included in the detailed description and accompanying drawings.

According to the above-mentioned construction of the present invention, an LCD can be protected from heat of high temperature environment by the heat-blocking film of the protection filter for an LCD. The protection filter for an LCD is used more effectively when being provided for an LCD installed out of doors.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view illustrating a protection filter for a liquid crystal display (LCD) according to an embodiment of the present invention;

FIG. 2 is a detailed view illustrating a heat-blocking film of the protection filter for the LCD of FIG. 1; and

FIG. 3 is a schematic view illustrating an LCD according to an embodiment of the present invention.

### DETAILED DESCRIPTION OF THE EXEMPLARY EMBODIMENT

Reference will now be made in greater detail to a preferred embodiment of the invention, an example of which is illustrated in the accompanying drawings. Wherever possible, the same reference numerals will be used throughout the drawings and the description to refer to the same or like parts.

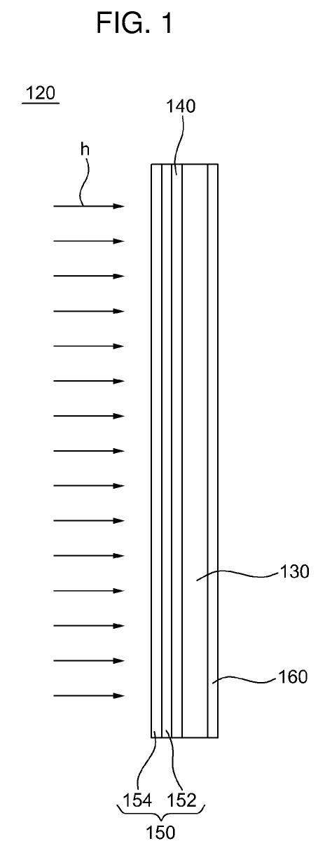

FIG. 1 is a schematic view illustrating a protection filter for a liquid crystal display (LCD) according to an embodiment of the present invention.

Referring to FIG. 1, the protection filter 120 for an LCD includes a transparent substrate 130 and a heat-blocking film 140 formed on the transparent substrate 130. The protection filter 130 may further include an anti-reflection (AR) film 150 and a shatterproof film 160 which are formed on the transparent substrate 130.

The transparent substrate 130 can be made of glass which is resistant to scratching and has a good strength, but the present invention is not limited thereto. For example, instead of the glass, the transparent substrate 130 can be made of transparent polymer resin, which may include one or more compounds selected from a group consisting of polyethylene terephthalate, polysulfone, polyethersulfone, polystyrene, polyethylene naphthalate, polyarylate, polyetheretherketone, polycarbonate, polypropylene, polyimide, triacetylcellulose, and polymethylmethacrylate.

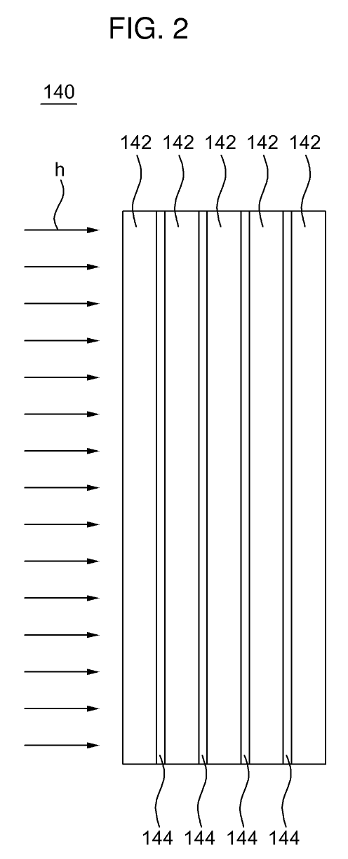

The heat-blocking film 140 can block heat entering from the outside. The heat-blocking film 140 will now be described in detail with reference to FIG. 2.

FIG. 2 is a detailed view illustrating the heat-blocking film of the protection filter for the LCD of FIG. 1.

In FIG. 2, the heat-blocking film 140 may include a metallic compound thin film 142 and a transparent metallic thin film 144 which are alternately formed on the transparent substrate 130. Here, the number of the metallic compound thin film 142 and the transparent metallic thin film 144, which are layered, may vary depending upon an external environment where an LCD is placed, and thus is not limited to a specified number.

The metallic compound thin film 142 may be transparent to visible rays, and has a refractive index different from a refractive index of the transparent metallic thin film 144, thereby preventing the reflection of visible rays.

The metallic compound thin film 142 may include a high refractive material having a refractive index of e.g. 1.4 or more for 550 nm wavelength rays.

Particularly, the metallic compound thin film 142 may include one or more compounds selected from a group consisting of: metal oxide, such as indium tin oxide (ITO), indium zinc oxide (IZO), zinc oxide (ZnO), Al-doped zinc oxide (AZO), titanium oxide (TiO₂), cadmium tin oxide (CTO), aluminum oxide (Al₂O₃), magnesium oxide (MgO), thorium oxide (ThO₂), tin oxide (SnO₂), lanthanum oxide (LaO₂), silicon oxide (SiO₂), indium oxide (In₂O₃), niobium oxide (Nb₂O₅), antimony oxide (Sb₂O₃), zirconium oxide (ZrO₂), cerium oxide (CeO₂), bismuth oxide (BiO₂), or the like; and metal sulfide, such as zinc sulfide (ZnS), cadmium sulfide (CdS), antimony sulfide (Sb₂S₃), or the like. Among them, ITO, ZnO, or TiO₂ can be preferable. This is because ITO and ZnO hardly absorb visible rays as well as have a high refractive index of about 2.0 for visible rays, and because TiO₂ has a high refractive index of about 2.3 for visible rays as well as has an insulating property.

The thickness of the metallic compound thin film 142 may have a range of 5 nm to 100 nm, and e.g. four to five metallic compound thin films may be provided on the transparent substrate. While the multiple metallic compound thin films 142 may have different or identical thicknesses from or to each other, the present invention is not limited thereto.

The transparent metallic thin film 144 may include Ag, which has excellent electric conductivity, high transmissivity to visible rays, and high resistance to heat (h). However, since Ag has low chemical and physical stabilities, and is ready to deteriorate under an external environment, the transparent metallic thin film 144 may include Ag alloy instead of Ag. The Ag alloy may contain, together with Ag, one or more metals, e.g. Au, Pt, Pd, Cu, In, Sn, or the like, which are stable under external environment. Meanwhile, since it is common that if another metal is added to Ag, the electric conductivity and optical characteristics deteriorate, at least one of transparent metallic thin films 144 may contain only Ag.

The transparent metallic thin film 144 may have a thickness of 3 nm to 30 nm, and four transparent metallic thin films in total may be provided on the transparent substrate. While the thickness of the transparent metallic thin films 144 which are layered, may be different or identical from or to each other, the present invention is not limited thereto because they can be determined in consideration of the transmissivity and electric conductivity of the metallic compound thin film 142.

The metallic compound thin film 142 and the transparent metallic thin film 144 may be formed using any one method among sputtering, ion plating, vacuum deposition, and plating.

For example, the metallic compound thin film 142 containing ITO may be formed using a reactive sputtering method which uses an indium based metal target or an indium oxide based sintered target. Further, the transparent metallic thin film 144 containing Ag may be formed using a sputtering method which uses an Ag contained target.

As set forth above, the protection filter for an LCD of the present invention can block external heat (h) by means of heat-blocking film 140. Thus, even though an LCD equipped with the protection filter 120 is exposed to the high temperature environment for a long period, the lifetime and display quality of the LCD are not degraded.

Referring again to FIG. 1, the anti-reflection film 150 is formed on the heat-blocking film 140 so as to reduce the reflection of light rays incident from outside, and it may include a base layer 152 and an anti-reflection layer 154.

The base layer 152 may include at least one transparent polymer resin selected from a group consisting of polyethylene terephthalate, polysulfone, polyethersulfone, polystyrene, polyethylene naphthalate, polyarylate, polyetheretherketone, polycarbonate, polypropylene, polyimide, triacetylcellulose, and polymethylmethacrylate.

The anti-reflection layer 154 may include two or more thin layers which have different refractive indices, and are composed of inorganic compound such as metal oxide, fluoride, silicide, boride, carbide, nitride, sulfide or the like, or organic compound such as silicon-based resin, acrylic resin, fluoric resin or the like. For example, the anti-reflection layer 154 may be composed of a low refractive oxide layer such as SiO₂, and a high refractive oxide layer such as TiO₂ which are alternately layered.

However, the anti-reflection layer 154 may be composed of a single layer. For example, the anti-reflection layer 154 may be composed of a single layer of transparent fluoric polymer resin, magnesium fluoride, silicon-based resin, silicon oxide or the like which has a refractive index of 1.5 or less, preferably 1.4 or less in a range of visible rays, and a thickness of a quarter of wavelength.

The shatterproof film 160 serves to prevent the transparent substrate 130 from shattering into pieces when the transparent substrate is broken due to external shocks. However, the shatterproof film 160 may be excluded according to the specifications of the transparent substrate 130 and an LCD equipped with the protection filter 120.

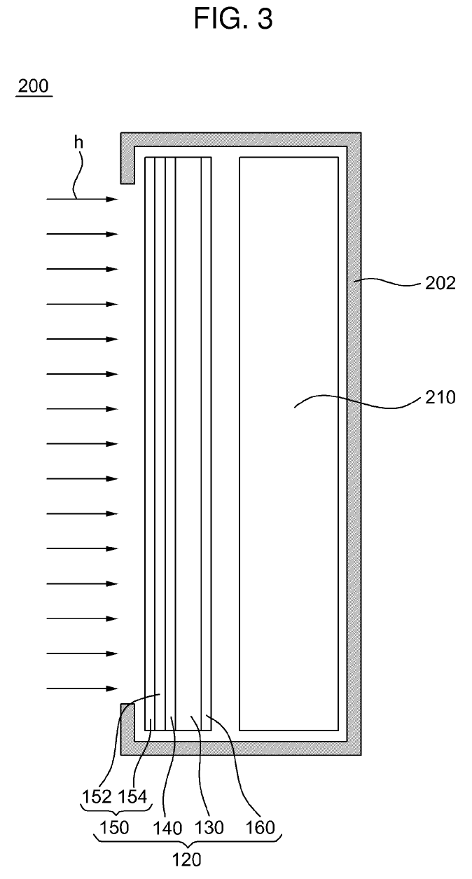

FIG. 3 is a schematic view illustrating an LCD according to an embodiment of the present invention. Since the protection filter shown in FIG. 3 is identical to that of FIG. 1, the same reference numeral is assigned thereto.

In FIG. 3, the LCD 200 of the present invention can be used as a public display, but the present invention is not limited thereto. The LCD 200 includes a display module 210 housed in a housing 202, and the protection filter 120.

The display module 210 includes a liquid crystal layer, although not shown in the figure, and displays an image using an electro-optical property of the liquid crystal layer.

The protection filter 120 can be disposed in front of the display module 210 to protect the display module from external environment. Particularly, since the protection filter 120 can block external heat (h), even when the LCD 200 is exposed to high temperature environment for a long time, the lifetime and display quality of the LCD 200 may not be degraded.

While the present invention has been described with respect to exemplary embodiments, those skilled in the art can understand that the present invention may be implemented in other ways within the technical scope or essential characteristics of the present invention.

Therefore, it should be understood that the exemplary embodiments of the present invention is provided only for illustrative purposes, and the present invention is defined only by the scope of following claims.

What is claimed is:

1. A protection filter for a liquid crystal display (LCD) comprising:
a transparent substrate; and
a heat-blocking film comprising a metallic compound thin film and a transparent metallic thin film which are alternately formed on the transparent substrate.

2. The protection filter according to claim 1, further comprising an anti-reflection (AR) film which is formed on the heat-blocking film to reduce the reflection of environmental light rays incident from outside.

3. The protection filter according to claim 1, wherein the metallic compound thin film comprises one or more compounds selected from a group consisting of indium tin oxide (ITO), indium zinc oxide (IZO), zinc oxide (ZnO), Al-doped zinc oxide (AZO), titanium oxide (TiO₂), cadmium tin oxide (CTO), aluminum oxide (Al₂O₃), magnesium oxide (MgO), thorium oxide (ThO₂), tin oxide (SnO₂), lanthanum oxide (LaO₂), silicon oxide (SiO₂), indium oxide (In₂O₃), niobium oxide (Nb₂O₅), antimony oxide (Sb₂O₃), zirconium oxide (ZrO₂), cerium oxide (CeO₂), bismuth oxide (BiO₂), zinc sulfide (ZnS), cadmium sulfide (CdS), and antimony sulfide (Sb₂S₃).

4. The protection filter according to claim 1, wherein the transparent metallic thin film contains Ag or Ag alloy.
